(19) United States
(12) Patent Application Publication
(10) Pub. No.: US 2015/0254247 A1
(43) Pub. Date: Sep. 10, 2015

(54) NATURAL LANGUAGE SEARCHING WITH COGNITIVE MODELING

(71) Applicant: International Business Machines Corporation, Armonk, NY (US)

(72) Inventors: James E. Bostick, Cedar Park, TX (US); Donna K. Byron, Petersham, MA (US); John M. Ganci, JR., Cary, NC (US); Craig M. Trim, Sylmar, CA (US)

(73) Assignee: International Business Machines Corporation, Armonk, NY (US)

(21) Appl. No.: 14/200,072

(22) Filed: Mar. 7, 2014

(51) Int. Cl. G06F 17/30

(52) U.S. Cl. CPC G06F 17/3053; G06F 17/30864; G06F 17/30241; G06F 17/30684

(57) ABSTRACT

Natural language searching is provided. A computing device receives a query that includes a portion of natural language; determines a first set of expressed attributes corresponding to the query; determines a plurality of search results, each associated with one or more characteristics of a destination, based, at least in part, on the query and on the first set of expressed attributes of the query; determines a second set of expressed attributes of the query based, at least in part, on the portion of natural language of the query, each of which corresponds to at least one characteristic of the one or more characteristics associated with the search results; and sorts the plurality of search results based, at least in part, on the second set of expressed attributes of the query and on the one or more characteristics associated with each of the plurality of search results.

### FIELD OF THE INVENTION

The present disclosure relates generally to the field of natural language searching, and more particularly to natural language searching with cognitive modeling.

### BACKGROUND OF THE INVENTION

Natural language processing (NLP) is a field of computer science, artificial intelligence, and linguistics concerned with the interactions between computers and human (i.e., natural) languages. Within the mobile phone market, devices known as “smart phones” often include NLP technologies that enable speech-to-text transcription. A smart phone user can perform a search utilizing speech as input. For example, the user may perform a search of the Internet using any of a variety of search engines.

Smart phones typically include location-awareness technologies, such as a global positioning system (GPS) sensor. The smart phone can combine this information with the speech input in order to perform a location-sensitive search.

### SUMMARY

Embodiments of the present invention provide a method, system, and computer program product for natural language searching. A computing device receives a query that includes a portion of natural language; determines a first set of expressed attributes corresponding to the query; determines a plurality of search results, each associated with one or more characteristics of a destination, based, at least in part, on the query and on the first set of expressed attributes of the query; determines a second set of expressed attributes of the query based, at least in part, on the portion of natural language of the query, each of which corresponds to at least one characteristic of the one or more characteristics associated with the search results; and sorts the plurality of search results based, at least in part, on the second set of expressed attributes of the query and on the one or more characteristics associated with each of the plurality of search results.

### BRIEF DESCRIPTION OF THE SEVERAL VIEWS OF THE DRAWINGS

FIG. 1 is a functional block diagram illustrating a natural language processing environment, in accordance with one embodiment of the present disclosure.

FIG. 2 is a flowchart depicting operational steps of a search program, on a server computer within the natural language processing environment of FIG. 1, for natural language searching, in accordance with one embodiment of the present disclosure.

FIG. 3 is a flowchart depicting operational steps of a sorting program, on a server computer within the natural language processing environment of FIG. 1, for sorting search results, in accordance with one embodiment of the present disclosure.

FIG. 4 is a flowchart depicting operational steps of a discount program, on a server computer within the natural language processing environment of FIG. 1, for negotiating a discount, in accordance with one embodiment of the present disclosure.

FIG. 5 is a block diagram of components of the server computer executing the search program, sorting program, and discount program, in accordance with one embodiment of the present disclosure.

### DETAILED DESCRIPTION

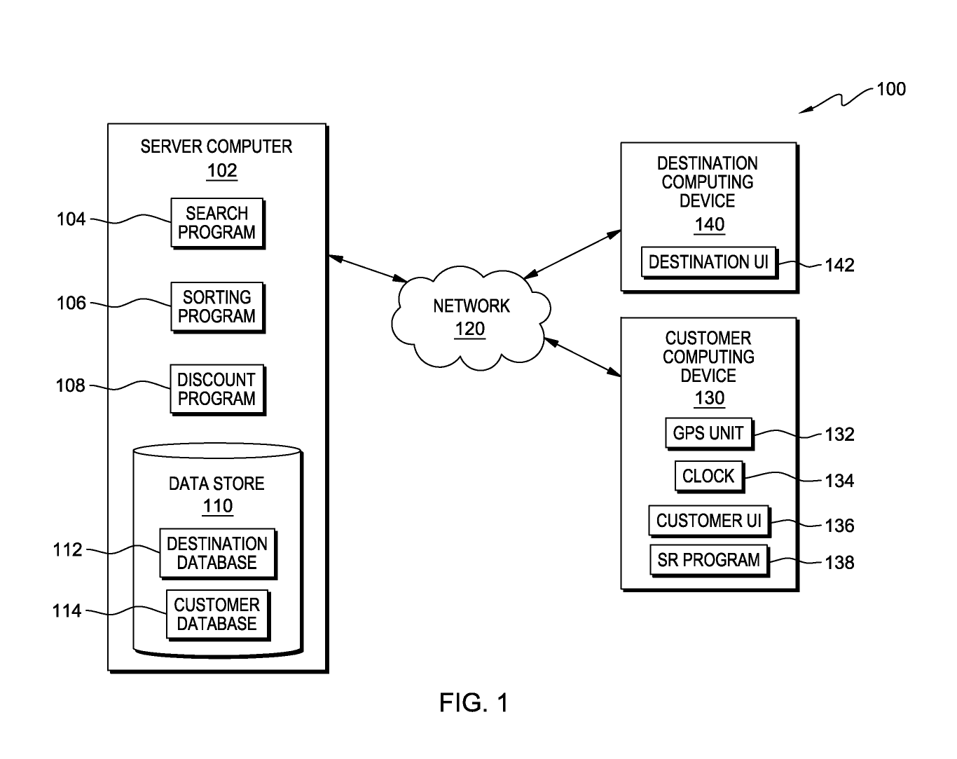

The present disclosure will now be described in detail with reference to the Figures. FIG. 1 is a functional block diagram illustrating a natural language processing environment, generally designated 100, in accordance with one embodiment of the present disclosure.

Natural language (NL) processing environment 100 includes server computer 102, customer computing device 130, and destination computing device 140, all interconnected over network 120.

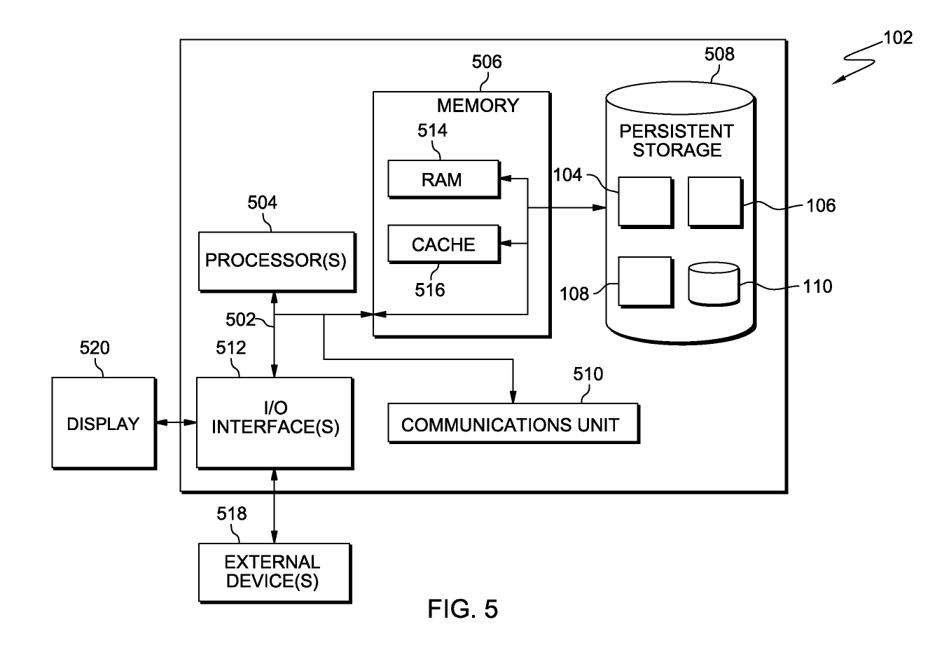

Server computer 102 may be a laptop computer, a tablet computer, a netbook computer, a personal computer (PC), a desktop computer, a personal digital assistant (PDA), a smart phone, or any programmable electronic device capable of communicating with customer computing device 130 and destination computing device 140 via network 120. In general, server computer 102 is representative of any programmable electronic device or combination of programmable electronic devices capable of executing machine-readable program instructions and communicating with other computing devices via a network. In other embodiments, server computer 102 may represent a server computing system utilizing multiple computers as a server system, such as in a cloud computing environment. Server computer 102 may be a cognitive computing server or a cognitive computing server system. Server computer 102 may include internal and external hardware components, as depicted and described in further detail with respect to FIG. 5. Server computer 102 includes search program 104, sorting program 106, discount program 108, and data store 110, which includes destination database 112 and customer database 114.

Server computer 102 can process a natural language text and can provide answers to questions expressed in natural language. Server computer 102 may be an artificial intelligent computer, for example an intelligent computing system adapted to perform a question answering (QA), natural language processing, data retrieval, logical reasoning, machine learning, or other intelligent computing operations. Server computer 102 may perform text analysis of the question and find answers by searching a collection of information such as a database or natural language documents, the World Wide Web, or other data and also performing text analysis on the searched data. The QA system retrieves relevant facts with evidence.

Search program 104 operates to perform NL searching. Search program 104 receives a query. Search program 104 processes NL input of the query. Search program 104 determines query attributes. Search program 104 performs NL search to determine search results. In one embodiment, search program 104 resides on server computer 102. In other embodiments, search program 104 may reside on another server computer or another computing device, provided that search program 104 is accessible by and can access sorting program 106, discount program 108, data store 110, customer computing device 130, and destination computing device 140.

Sorting program 106 operates to sort search results. Sorting program 106 receives search results. Sorting program 106 receives default search preferences. Sorting program 106 determines whether user search preferences are set. If sorting program 106 determines that user search preferences are set, sorting program 106 overrides the default search preferences. Sorting program 106 determines one or more implicitly expressed attributes. Sorting program 106 applies attributes to the search results. Sorting program 106 sorts the search results. Sorting program 106 presents the sorted search results. In one embodiment, sorting program 106 resides on server computer 102. In other embodiments, sorting program 106 may reside on another server computer or another computing device, provided that sorting program 106 is accessible by and can access search program 104, discount program 108, data store 110, customer computing device 130, and destination computing device 140.

The attributes of a search query includes at least one set of expressed attributes that are expressed (either explicitly or implicitly) by the search query. Explicitly expressed attributes may include metadata associated with the search query. For example, a search query received from a mobile device may be associated with metadata such as a time, a location, or both. Implicitly expressed attributes may include attributes that are expressed by the query without being explicitly expressed, such as implied attributes. For example, the query “What movies are playing this afternoon?” implies a time other than the time at which the query was generated, in which case the implicitly expressed attributes of the query includes the time implied by the query. Alternatively, implicitly expressed attributes of a query may include attributes such as a category of destinations, a date, a day of the week, a location, a time of the year or a season, current or forecasted weather conditions, a purchase history (e.g., of the customer who performed the search), an availability of a discount, an amount of a discount, or any combination thereof. Each implicitly expressed attribute may relate to a condition, current or otherwise. For example, the implicitly expressed attributes of a query may include a date, which may be the current date, a date in the past, or a date in the future.

Aspects of the present disclosure may utilize semantic triple extraction, for example in the performance of natural language processing. Semantic triple extraction determines a triple data structure that represents a portion of natural language and comprises a predicate, a subject, and an object, wherein the predicate identifies an action or function; the subject performs the predicate action or function or is an input to the predicate action or function; and the object is a result of performing the predicate action or function or is an entity upon which the predicate action or function is performed. Semantic triple extraction may include one or more of the following operations: dependency parsing, triple extraction, morphological analysis, triple normalization, and restatement. For example, aspects of the present disclosure may utilize semantic triple extraction for the portion of natural language: “my internet connection is down.” Dependency parsing includes determining a series of tokens by parsing the portion of natural language to (e.g., “my”; “internet”; “connection”; “is”; “down”). Triple extraction includes determining relationships and/or dependencies between and among the tokens based on the grammatical type of each token (e.g., “my” and “internet” are each modifiers of “connection”). Triple extraction includes determining a triple data structure based on the relationships and/or dependencies (e.g., the predicate is “is,” the subject is “connection” modified by “my” and “internet” and the object is “down”). Morphological analysis includes the analysis of the morphology of a token, including suffixes and prefixes, to determine synonyms, alternative phrasings, or semantic content of the token (e.g., “connection” includes the suffix—ion). Triple normalization includes normalizing negated tokens to positive phrasing (e.g., “is down” negates “internet connection”). Restatement includes restating the portion of natural language in alternative phrasing (e.g., “I′m sorry to hear that you can't connect to the internet.”).

Aspects of the present disclosure may utilize interactive query refinement. Interactive query refinement improves the accuracy of (i.e., refines) an interpretation of a query based on responses to clarifying counter-queries generated based on the original query. Interactive query refinement may be an iterative process, including multiple rounds of queries and counter-queries. Interactive query refinement may disambiguate between interpretations of a query. For example, a user may query “What's a good place to eat?” If the time of the query falls at (or within a specified difference of) the border between two pre-determined meal times, then the meal time of the interpretation is ambiguous. Interactive query refinement can provide a counter-query to resolve the ambiguity of the interpretation. The counter-query may be “Are you hungry for lunch or dinner?” Interactive query refinement receives an answer (e.g., “lunch”) and, in response, resolves the ambiguity of the query.

Discount program 108 operates to negotiate a discount. Discount program 108 receives customer details. The customer details include customer attributes that correspond to a customer (e.g., a user of customer computing device 130). Discount program 108 modifies the search results. Discount program 108 modifying the search results may be based, at least in part, on the negotiated discount for each destination. Discount program 108 presents the search results. In one embodiment, discount program 108 resides on server computer 102. In other embodiments, discount program 108 may reside on another server computer or another computing device, provided that discount program 108 can access and is accessible by search program 104, sorting program 106, data store 110, customer computing device 130, and destination computing device 140.

Data store 110 is a data repository that may be written to and read by search program 104, sorting program 106, and discount program 108. Customer search preferences, customer details, a discount policy, or a combination thereof may be stored to data store 110. In some embodiments, data store 110 may be written to and read by programs and entities outside of NL processing environment 100 to populate the repository with customer search preferences, customer details, a discount policy, or a combination thereof. In one embodiment, data store 110 resides on server computer 102. In other embodiments, data store 110 may reside on another server computer, another computing device, customer computing device 130, or destination computing device 140, provided that data store 110 is accessible to search program 104, sorting program 106, and discount program 108. Data store 110 includes destination database 112 and customer database 114.

Destination database 112 of data store 110 may store destination data for one or more destinations. The destination data corresponds to a destination and may include, e.g., a discount policy and one or more characteristics. The characteristics of a destination may include, for example, hours of operation, an address or other location (e.g., GPS coordinates), seasonal operation information, whether the destination is indoors or outdoors, or a combination thereof. The characteristics may also identify a destination computing device (e.g., destination computing device 130) corresponding to the destination. For example, the characteristics of a destination may identify a user name, an internet protocol (IP) address, an email account, or another identifier that identifies a destination computing device corresponding to the destination.

A discount policy identifies eligibility criteria for a discount. The discount policy corresponds to a destination. The discount policy may include a criterion requiring a minimum party of size in order to receive any discount. For example, a discount policy for a golf course may include a criterion requiring a minimum party size of four. Alternatively, a criterion may scale a discount based on the purchase history of a customer. For example, a discount policy for a restaurant may include a criterion that offers greater discounts to customers who visit frequently, as determined based on the purchase history of each customer. A discount policy may identify multiple sets of criteria that each correspond to a discount amount. For example, a destination may offer a 10% discount for customers who have previously made six separate purchases at the destination and a 5% discount for customers who have made at least three, but less than six, separate purchases at the destination.

Customer database 114 of data store 110 may store customer details corresponding to each of one or more customers. Customer details include customer attributes. The customer attributes may include customer preferences. Customer preferences include comparison scope settings, which can control the amount and type of information from the customer attributes that discount program 108 sends to destination computing device 140 when, e.g., negotiating a discount. The comparison scope settings may limit the precision of information that discount program 108 sends. For example, the precision of purchase amounts in a purchase history of a customer may be reduced in precision to reflect relative measures of spending amounts, such as “high spender” or “low spender” categories. Such relative measures may be determined by discount program 108 by comparing the purchase history of the customer to purchase histories of other customers or to pre-determined threshold amounts. Alternatively, the comparison scope settings may limit the time frame of information that discount program 108 sends. For example, the time frame may be reduced in order to send only those portions of the purchase history that include transactions less than one year old. The comparison scope settings may also limit the scope of customer attributes that discount program 108 sends in other ways, such as by limiting the information to only the portions of the purchase history including transactions corresponding to a particular destination, or by completely limiting the information that discount program 108 sends, thereby preventing discount program 108 from sending any of the customer attributes to a destination. Discount program 108 may negotiate a discount for each destination identified by received search results based, at least in part, on a discount policy of the destination and the customer attributes, subject to the comparison scope settings. Customer attributes may include a purchase history corresponding to a customer. A purchase history is a data structure that includes historical data associated with a customer. The purchase history for a customer identifies destinations the customer has visited and, for each destination, the purchase history includes a variety of historical data. For example, the historical data may include the number visits, the frequency of visits, the time and date of the visits, the time passed since the last visit, purchases made at each visit, amounts spent during each visit, party size during each visit, or any combination thereof. The customer attributes may also include information corresponding to the customer from publically available sources such as public web sites or databases. Alternatively, the customer attributes may include information provided by the customer, such as data from a social media profile to which the customer granted access.

Customer database 114 of data store 110 may store search preferences corresponding to each of one or more customers. Search preferences include one or more weight values that each correspond to an attribute that a query may express. Each weight value may represent an importance of the corresponding attribute to a customer. Customer database 114 may also store default search preferences, which include default values for each weight value. For example, the default value for each weight value may be equal to one another, thereby weighting each attribute equally relative to one another. Customer search preferences include values specified by a customer for one or more weight values. Customer search preferences may include a default weight value for each attribute for which there is no customer-specified weight value. For example, a customer may specify a high weight value for a first attribute and a low weight value for a second attribute in order to prioritize the first attribute over the second attribute.

In various embodiments of the present disclosure, customer computing device 130 and destination computing device 140 can each, respectively, be a laptop computer, a tablet computer, a netbook computer, a personal computer (PC), a desktop computer, a personal digital assistant (PDA), a smart phone, or any programmable electronic device capable of communicating with one another and with server computer 102 via network 120. In general, customer computing device 130 and destination computing device 140 are each representative of any programmable electronic device or combination of programmable electronic devices capable of executing machine-readable program instructions and communicating with other computing devices via a network. In other embodiments, customer computing device 130 and destination computing device 140 may each represent a customer computing device system or a destination computing device system, respectively, utilizing multiple computers as a computing device system, such as in a cloud computing environment. Customer computing device 130 and destination computing device 140 may each include internal and external hardware components, as depicted and described in further detail with respect to FIG. 5.

In this embodiment, customer computing device 130 includes applications that execute locally on customer computing device 130, including global positioning system (GPS) unit 132, clock 134, customer user interface (UI) 136, and SR program 138. GPS unit 132 operates to provide location data. For example, GPS unit 132 provides location data indicating the geographical location (e.g., an address or GPS coordinates) of customer computing device 130. Clock 134 operates to provide time data. For example, clock 134 provides time data identifying the current time. Customer UI 136 operates to provide a user interface (UI) to a user (e.g., a customer). Customer UI 136 can present information and receive user input. For example, customer UI 136 can receive user input from a user in response to presenting a prompt to the user. Customer UI 136 can associate the user input with location data and time data. SR program 138 operates to perform speech recognition (SR) to convert speech (i.e., spoken words) to text. Customer computing device 130 is communicatively linked with one or both of server computer 102 and destination computing device 140 via network 120. For example, customer UI 136 receives speech input in response to providing a search prompt via a UI. Customer UI 136 associates the speech input with location data provided by GPS unit 132 and time data provided by clock 134. SR program 138 performs SR on the speech input to convert the speech input to text that includes a search query. Customer computing device 130 sends the speech query, the associated time data, and the associated location data, to search program 104 of server computer 102.

In this embodiment, destination computing device 140 includes applications that execute locally on destination computing device 140, including destination UI 142. Destination UI 142 operates to provide a user interface (UI) to a user (e.g., a destination representative). Destination UI 142 can present information and receive user input. For example, destination UI 142 can receive user input from a user in response to presenting a prompt to the user. In one embodiment, destination UI 142 receives user input that includes a discount policy in response to providing a prompt to a user. Alternatively, destination UI 142 may display a discount request and, in response, may receive a discount decision. For example, destination computing device 140 may receive a discount request in response to a user of customer computing device 130 performing a search, and a user of destination computing device 140 may respond to the discount request by providing a discount decision via destination UI 142.

A destination may be a business, event, venue, activity, attraction, or location. In one embodiment, the destination can generally be any recreational, commercial, or entertainment destination. For example, the destination can be a restaurant, a sporting event, a ski slope, a sightseeing destination, a museum, or any of various other recreational, commercial, or entertainment destinations.

Network 120 can be, for example, a local area network (LAN), a wide area network (WAN) such as the Internet, or a combination of the two, and can include wired, wireless, or fiber optic connections. In general, network 120 can be any combination of connections and protocols that will support communications between server computer 102 and SR computing devices 104, 106, and 108.

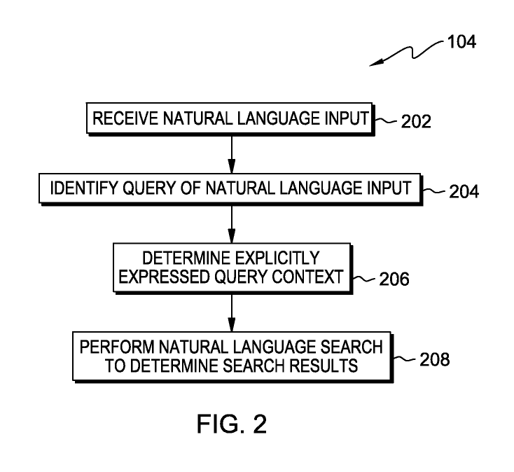

FIG. 2 is a flowchart depicting operational steps of search program 104, on server computer 102 within NL processing environment 100, for NL searching, in accordance with one embodiment of the present disclosure.

In step 202, search program 104 receives a natural language (NL) input. In one embodiment, search program 104 receives the NL input from customer computing device 130. The NL input may include a portion of NL, which may include a query. The NL input may include metadata, which is data that describes or otherwise relates to a query.

In step 204, search program 104 identifies a query of the NL input. In one embodiment, search program 104 identifies a query by identifying a portion of NL within the NL input that includes a question that may be directly or implicitly expressed. For example, the query may be a question such as, “Where is a good place to eat?” Alternatively, the query may imply a question, such as, “I feel like lunch,” which implies the question, “Where can I eat lunch?”

In step 206, search program 104 determines explicitly expressed attributes of a query. In one embodiment, the explicitly expressed attributes includes attributes expressed by the metadata of the query. In other embodiments, the explicitly expressed attributes includes a location, a time, or both. For example, the location may be a location of SR computing device 130, as generated by GPS unit 132. In another example, the time may be a time at which SR computing device 130 sent the query, as determined by clock 134.

In step 208, search program 104 performs NL search to determine search results. In one embodiment, search program 104 searches a database of destinations to determine search results based on the query and the explicitly expressed attributes. For example, search program 104 may search destination database 112 of data store 110. The search results identify at least one search result. For example, the search results may identify a plurality of destinations, in which case each identified destination is a search result, and “search results” refers collectively to the plurality of destinations. Some or all of the search results may be associated with one or more characteristics. The search results may include zero or more search results that are each associated with one or more characteristics and zero or more search results that are associated with no characteristics. The search results may be sorted or unsorted. For example, the search results may be sorted by distance relative to the search location, by alphabetical order, by one or more characteristics of one or more of the search results, by a value associated with each destination (e.g., a customer review rating), or by another metric.

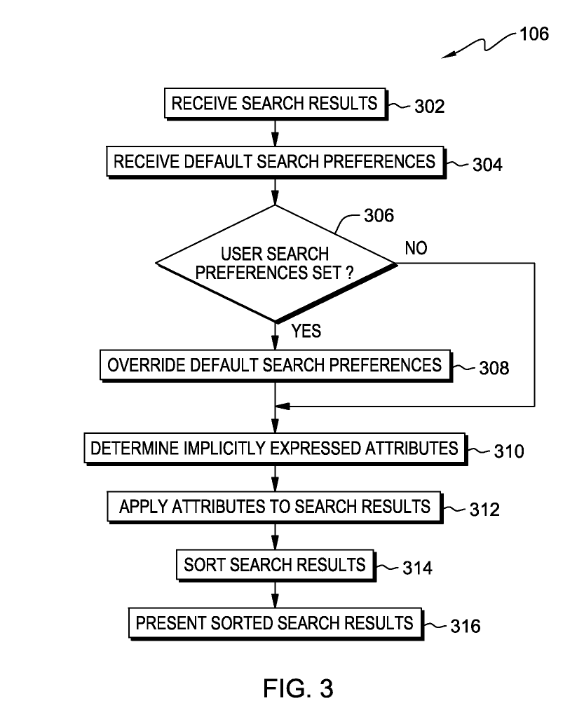

FIG. 3 is a flowchart depicting operational steps of sorting program 106, on server computer 102 within NL processing environment 100, for sorting search results, in accordance with one embodiment of the present disclosure.

In step 302, sorting program 106 receives search results. Sorting program 106 receives the search results from search program 104. Alternatively, sorting program 106 may receive the search results from discount program 108, destination computing device 140, or customer computing device 130, or sorting program 106 may retrieve the search results from data store 110 (e.g., from customer database 114 of data store 110). The search results may be sorted according to one or more metrics. For example, the search results may be sorted according to location, distance relative to a search location, alphabetical order, or any other logical ordering. Alternatively, the search results may be unsorted.

In some embodiments, the search results identify one or more destinations. Each destination is associated with one or more characteristics. For example, a destination for a ski resort which is open only during the winter may be associated with a seasonal characteristic that identifies the destination as available during the winter and unavailable during the spring, summer, and fall. Alternatively, a destination for a restaurant may include a characteristic that identifies an approximate or relative price range for the restaurant.

In step 304, sorting program 106 receives default search preferences. The default search preferences include default values for each weight value. The default search preferences reside in data store 110. Alternatively, the default search preferences may reside in sorting program 106, customer database 114, or customer computing device 130.

In decision 306, sorting program 106 determines whether customer search preferences are set. Customer search preferences reside in customer database 114. Alternatively, customer search preferences may reside in data store 110, sorting program 106, or customer computing device 130. In one embodiment, sorting program 106 determines whether the customer search preferences are set based on whether customer database 114 includes customer search preferences. In another embodiment, sorting program 106 determines whether the customer search preferences are set based on whether sorting program 106 receives customer search preferences from customer computing device 130. If sorting program 106 determines that customer search preferences are set (decision 306, YES branch), then sorting program 106 overrides default search preferences (step 308). If sorting program 106 determines that the customer search preferences are not set (decision 306, NO branch), then sorting program 106 determines implicitly expressed attributes (step 310). Alternatively, if sorting program 106 determines that the customer search preferences are not set (decision 306, NO branch), then sorting program 106 does not override the default search preferences.

In step 308, sorting program 106 overrides default search preferences. In one embodiment, sorting program 106 overrides default search preferences based on customer search preferences. Alternatively, sorting program 106 overrides only the portions of the default search preferences that conflict with the customer search preferences. For example, if both the default search preferences and the customer search preferences include a weight value for an attribute, then storing program 106 overrides the default weight value for the attribute with the customer-specified weight value for the attribute. Storing program 106 overrides a weight value for an attribute by utilizing the weight value of the user search preferences if available and the weight value of the default search preferences otherwise.

In step 310, sorting program 106 determines implicitly expressed attributes of the query. Sorting program 106 may determine implicitly expressed content of a query by performing natural language processing of the query. The implicitly expressed attributes of a query may include, for example, a user purchase history or other historical data (e.g., location data), a time of day, a time of year or season, or weather conditions (e.g., current or forecasted weather conditions). Sorting program 106 may compare the historical data for a customer to the destinations of the search results. For example, sorting program 106 may determine whether the customer has visited a destination of the search results in the past. Alternatively, sorting program 106 may determine that a query does not have a certain implicitly expressed attribute. For example, a query such as, “Identify local landmarks” implicitly expresses a location attribute, but does not implicitly express a seasonal attribute, as the existence of a landmark is independent on the time of year or season. Sorting program 106 may utilize a variety of natural language processing techniques in order to determine the semantic content of the query. For example, sorting program 106 may utilize semantic triple extraction, interactive query refinement, resource description framework (RDF) model representation, or a combination thereof.

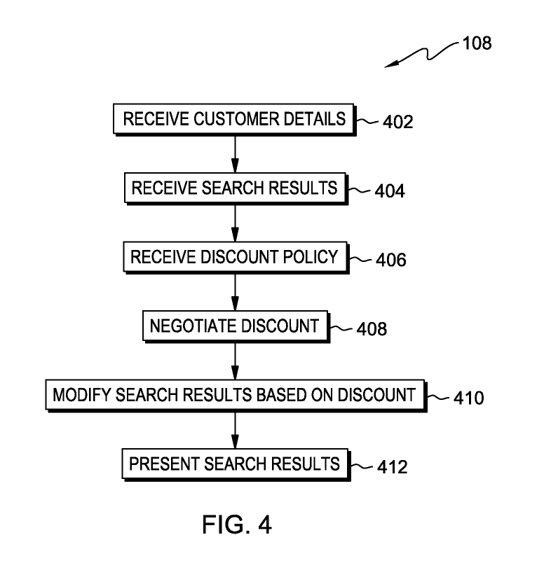

In some embodiments, the implicitly expressed attributes include a discount amount. Sorting program 106 may utilize some or all of the functionality of discount program 108 in order to determine a discount amount for each destination of the search results. Alternatively, sorting program 106 may include some or all of the functionality of discount program 108 in order to determine a discount amount for each destination of the search results. Sorting program 106 may determine that the implicitly expresses attributes of a query includes a discount amount. The functionality of discount program 108 is discussed more fully in connection with FIG. 4.

In step 312, sorting program 106 applies attributes to the search results. Sorting program 106 may apply attributes to each destination of the search results by comparing the implicitly and explicitly expressed attributes of the query to the characteristics of the destination. For example, sorting program 106 may apply the attributes of a query to a destination to determine that the destination is an outdoor activity and the local weather is forecasted to be poor. Sorting program 106 may apply attributes to the search results by determining a relevance score for each destination of the search results, which is a value that represents how relevant the search result is to the customer. In various examples, sorting program 106 may determine the relevance score for each destination based on the explicitly expressed attributes of the query, the implicitly expressed attributes of the query, one or more characteristics of the destination, the search preferences, or a combination thereof. For example, sorting program 106 may apply attributes such as the time of day to a query such as “What is a good place for dinner?” In this case, sorting program 106 may determine a relevance score for each destination of the search results based, at least in part, on a characteristic of the destination identifying times of availability. Thus, sorting program 106 may determine a low relevance score for a restaurant destination with times of availability from, for example, 6:00 AM through 2:00 PM, as it is not available during the time frame expressed by the query.

In step 314, sorting program 106 sorts the search results. Sorting program 106 sorts the search results in order to generate sorted search results. Sorting program 106 may sort the search results according to the relevance score of each destination of the search results. In some embodiments, sorting program 106 omits destinations with a relevance score below a pre-determined threshold from the sorted search results. Sorting program 106 may thereby omit destinations that sorting program 106 determines to be irrelevant or insufficiently relevant.

In step 316, sorting program 106 presents the sorted search results. Sorting program 106 presents the sorted search results by providing the sorted search results to the source from which search program 104 received the NL input. For example, search program 104 may receive NL input from customer computing device 130, in which case sorting program 106 provides the sorted search results to customer computing device 130. Alternatively, sorting program 106 provides the sorted search results to a device identified by the NL input. Alternatively, sorting program 106 provides the sorted search results by storing the sorted search results to data store 110.

FIG. 4 is a flowchart depicting operational steps of discount program 108, on server computer 102 within NL processing environment 100, for negotiating a discount, in accordance with one embodiment of the present disclosure.

In step 402, discount program 108 receives customer details. The customer details include customer attributes. Discount program 108 receives the customer details from customer computing device 130. Alternatively, discount program 108 receives the customer details by retrieving the customer details from data store 110, or from destination computing device 140. As stated previously, the customer details may include a purchase history. The customer details may include customer attributes such as customer preferences, which may include comparison scope settings. Discount program 108 may receive the customer details in response to a search performed by a user of customer computing device 130.

In step 404, discount program 108 receives search results. The search results identify one or more destinations. Discount program 108 receives the search results from search program 104. Alternatively, discount program 108 may receive the search results from sorting program 104, destination computing device 140, or customer computing device 130, or discount program 108 may retrieve the search results from data set 110 (e.g., from customer database 114 of data set 110). The search results may be sorted according to one or more metrics. For example, the search results may be sorted by sorting program 106, or according to location, distance relative to a search location, alphabetical order, or any other logical ordering. Alternatively, the search results may be unsorted.

In step 406, discount program 108 receives a discount policy. Discount program 108 receives a discount policy for one or more of the destinations identified by the search results. For example, discount program 108 may receive a discount policy for each destination identified by the search results. The discount policy includes one or more eligibility criteria for a discount. A discount policy for a destination may identify a discount amount automatically available if certain criteria are met. Alternatively, a discount policy may require manual approval of a discount amount. For example, a discount policy for a destination may require manual approval by a representative of the destination. The representative may be a user of destination computing device 140, which may receive an approval decision from the user via destination UI 142. In this case, discount program 108 may receive the approval decision from destination computing device 140. In some embodiments, a discount policy requires both that certain criteria are met and manual approval of a discount amount. For example, a discount policy for a movie theater may require both a party size of five and manual approval by a representative of the movie theater. Manual approval may be indicated by user input received by destination UI 142 in response to destination UI 142 presenting a discount request.

In step 408, discount program 108 negotiates a discount. Discount program 108 negotiates a discount based, at least in part, on the customer attributes and the discount policy. Discount program 108 may compare information of the customer attributes to a discount policy to determine whether the customer attributes meet the criteria of the discount policy. For example, discount program 108 may compare the purchase history of the customer attributes to a discount policy to determine whether the customer attributes meet the discount policy criterion that requires three previous purchases from the destination within the past three months. Alternatively, discount program 108 may, in response to a discount policy that requires manual approval, send some or all of the customer attributes for approval. For example, discount program 108 may send some or all of the customer attributes to destination computing device 140 for approval of a discount amount. In one embodiment, if a discount policy allows multiple discount amounts, discount program 108 automatically negotiates the highest discount amount for which the customer is eligible based on the customer attributes.

In some embodiments, discount program 108 negotiates a discount by sending a discount request to destination computing device 140 and, in response, receiving a discount decision. The discount request may include some or all of the customer attributes, a requested discount amount, and a date, time, or both during which the discount is requested. Discount program 108 may send a discount request to a destination computing device (e.g., destination computing device 140) corresponding to a destination identified in the search results. For example, a discount request corresponding to a customer (e.g., a user of customer computing device 130) may request a ten percent discount for a party of eight for a 6:00 PM reservation, and may include a purchase history or other customer attributes of the customer. Destination UI 142 may present the discount request to a user of destination computing device 140 and, in response, receive a discount decision (i.e., manual approval of the discount request). Discount program 108 may receive the discount decision, which indicates whether the destination accepts, declines, or counters the discount request, from destination computer device 140. If the destination accepts the discount request, then discount program 108 determines the negotiated discount to be the discount of the discount request.

In step 410, discount program 108 modifies the search results based on each discount. Discount program 108 modifies the search results to display the negotiated discount for each destination. Alternatively, discount program 108 sorts the search results based, solely or partially, on the negotiated discount. For example, discount program 108 may sort the search results to promote a destination with a negotiated discount to the first position in the search results. In some embodiment, discount program 108 modifies the search results by associating each destination with the negotiated discount amount. For example, discount program 108 may negotiate a discount for each destination in order for sorting program 106 to utilize the discount amount as an attribute.

In step 412, discount program 108 presents the search results. Discount program 108 presents the search results by sending the search results to customer computing device 130. Alternatively, discount program 108 presents the search results by sending the search results to destination computing device 140, or by storing the search results to data store 110. In some embodiments, discount program 108 presents the search results by sending the search results and discount amounts to sorting program 106.

FIG. 5 depicts a block diagram of components of server computer 102 in accordance with an illustrative embodiment of the present disclosure. It should be appreciated that FIG. 5 provides only an illustration of one implementation and does not imply any limitations with regard to the environments in which different embodiments may be implemented. Many modifications to the depicted environment may be made.

Server computer 102 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Search program 104, sorting program 106, discount program 108, and data store 110 are stored in persistent storage 508 for execution and/or access by one or more of the respective computer processor(s) 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of customer computing device 130 and destination computing device 140. In these examples, communications unit 510 includes one or more network interface cards. Communications unit 510 may provide communications through the use of either or both physical and wireless communications links. Search program 104, sorting program 106, discount program 108, and data store 110 may be downloaded to persistent storage 508 through communications unit 510.

I/O interface(s) 512 allows for input and output of data with other devices that may be connected to server computer 102. For example, I/O interface(s) 512 may provide a connection to external devices 518 such as a keyboard, a keypad, a touch screen, and/or some other suitable input device. External devices 518 can also include portable computer-readable storage media such as, for example, thumb drives, portable optical or magnetic disks, and memory cards. Software and data used to practice embodiments of the present disclosure, e.g., search program 104, sorting program 106, discount program 108, and data store 110, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The term(s) “Smalltalk” and the like may be subject to trademark rights in various jurisdictions throughout the world and are used here only in reference to the products or services properly denominated by the marks to the extent that such trademark rights may exist.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for natural language searching, the method comprising:
receiving, by a computing device, a query that includes a portion of natural language;
determining, by the computing device, a first set of expressed attributes corresponding to the query;
determining, by the computing device, a plurality of search results based, at least in part, on the query and on the first set of expressed attributes of the query, wherein each of the plurality of search results is associated with one or more characteristics of a destination;
determining, by the computing device, a second set of expressed attributes of the query based, at least in part, on the portion of natural language of the query, wherein each of the second set of expressed attributes corresponds to at least one characteristic of the one or more characteristics associated with the search results; and
sorting, by the computing device, the plurality of search results based, at least in part, on the second set of expressed attributes of the query and on the one or more characteristics associated with each of the plurality of search results.

2. The method of claim 1, wherein determining, by the computing device, the second set of expressed attributes of the query comprises determining, by the computing device, a frequency value that represents a frequency of a first search result within a purchase history of a user.

3. The method of claim 1, wherein determining, by the computing device, the second set of expressed attributes of the query comprises determining, by the computing device, a time of day that is implied based, at least in part, on the natural language of the query.

4. The method of claim 1, wherein determining, by the computing device, the second set of expressed attributes of the query comprises determining, by the computing device, a season of year that is implied based, at least in part, on the natural language of the query.

5. The method of claim 1, wherein determining, by the computing device, the second set of expressed attributes of the query comprises determining, by the computing device, a weather condition that is implied based, at least in part, on the natural language of the query.

6. The method of claim 1, further comprising:
receiving, by the computing device, a first weight value, wherein the first weight value corresponds to a first expressed attribute of the second set of expressed attributes and wherein the first weight value represents an importance of the first expressed attribute to a user.

7. The method of claim 6, wherein sorting, by the computing device, the one or more search results is further based, at least in part, on the first weight value.

8. The method of claim 1, wherein receiving the query comprises receiving, by the computer processor, the query from a client device, and wherein the first set of expressed attributes includes a geographical location corresponding to the client device.

9. A computer program product for natural language searching, the computer program product comprising a computer readable storage medium having program instructions embodied therewith, the program instructions executable by a computing device to cause the computing device to perform a method comprising:
receiving, by a computing device, a query that includes a portion of natural language;
determining, by the computing device, a first set of expressed attributes corresponding to the query;
determining, by the computing device, a plurality of search results based, at least in part, on the query and on the first set of expressed attributes of the query, wherein each of the plurality of search results is associated with one or more characteristics of a destination;
determining, by the computing device, a second set of expressed attributes of the query based, at least in part, on the portion of natural language of the query, wherein each of the second set of expressed attributes corresponds to at least one characteristic of the one or more characteristics associated with the search results; and
sorting, by the computing device, the plurality of search results based, at least in part, on the second set of expressed attributes of the query and on the one or more characteristics associated with each of the plurality of search results.

10. The computer program product of claim 9, wherein determining, by the computing device, the second set of expressed attributes of the query comprises determining, by the computing device, a frequency value that represents a frequency of a first search result within a purchase history of a user.

11. The computer program product of claim 9, wherein determining, by the computing device, the second set of expressed attributes of the query comprises determining, by the computing device, a time of day that is implied based, at least in part, on the natural language of the query.

12. The computer program product of claim 9, wherein determining, by the computing device, the second set of expressed attributes of the query comprises determining, by the computing device, a season of year that is implied based, at least in part, on the natural language of the query.

13. The computer program product of claim 9, wherein determining, by the computing device, the second set of expressed attributes of the query comprises determining, by the computing device, a weather condition that is implied based, at least in part, on the natural language of the query.

14. The computer program product of claim 9, wherein the method further comprises:
receiving, by the computing device, a first weight value, wherein the first weight value corresponds to a first expressed attribute of the second set of expressed attributes and wherein the first weight value represents an importance of the first expressed attribute to a user.

15. A computer system for natural language searching, the computer system comprising:
a memory; and
a processor in communication with the memory, wherein the computer system is configured to perform a method, said method comprising:
receiving, by a computing device, a query that includes a portion of natural language;
determining, by the computing device, a first set of expressed attributes corresponding to the query;
determining, by the computing device, a plurality of search results based, at least in part, on the query and on the first set of expressed attributes of the query, wherein each of the plurality of search results is associated with one or more characteristics of a destination;
determining, by the computing device, a second set of expressed attributes of the query based, at least in part, on the portion of natural language of the query, wherein each of the second set of expressed attributes corresponds to at least one characteristic of the one or more characteristics associated with the search results; and
sorting, by the computing device, the plurality of search results based, at least in part, on the second set of expressed attributes of the query and on the one or more characteristics associated with each of the plurality of search results.

16. The computer system of claim 15, wherein determining, by the computing device, the second set of expressed attributes of the query comprises determining, by the computing device, a frequency value that represents a frequency of a first search result within a purchase history of a user.

17. The computer system of claim 15, wherein determining, by the computing device, the second set of expressed attributes of the query comprises determining, by the computing device, a time of day that is implied based, at least in part, on the natural language of the query.

18. The computer system of claim 15, wherein determining, by the computing device, the second set of expressed attributes of the query comprises determining, by the computing device, a season of year that is implied based, at least in part, on the natural language of the query.

19. The computer system of claim 15, wherein determining, by the computing device, the second set of expressed attributes of the query comprises determining, by the computing device, a weather condition that is implied based, at least in part, on the natural language of the query.

20. The computer system of claim 15, wherein the method further comprises:
receiving, by the computing device, a first weight value, wherein the first weight value corresponds to a first expressed attribute of the second set of expressed attributes and wherein the first weight value represents an importance of the first expressed attribute to a user.
